(19) United States
(12) Patent Application Publication
(10) Pub. No.: US 2004/0031370 A1
(43) Pub. Date: Feb. 19, 2004

(54) Acoustic device

(76) Inventors: Noboru Ueno, Suwa-gun (JP); Akihiko Isaka, Suwa-gun (JP); Katsuhiko Yoshimura, Suwa-gun (JP); Katsuki Miyamoto, Suwa-gun (JP)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/454,117

(22) Filed: Jun. 4, 2003

(30) Foreign Application Priority Data
Jun. 5, 2002 (JP) 2002-164219
Dec. 9, 2002 (JP) 2002-356382

(51) Int. Cl. G10F 1/06

(52) U.S. Cl. 84/94.1

(57) ABSTRACT

An acoustic device having a sound volume control is provided. The device includes a sound generating body and a resonator having a mount member to which the sound generating body is mounted. According to the invention, a sound control member is provided to control the transmission of sound from the sound generating body to the resonator to control the sound volume. In one aspect, the sound control member is capable of adjusting a contact pressure between the sound generating body and the mount member to vary the sound volume more precisely.

### CROSS-REFERENCE TO RELATED APPLICATIONS

This application claims priority to Japanese Patent Application No. 2002-164219, filed Jun. 5, 2002 and Japanese Patent Application No. 2002-356382, filed Dec. 5, 2002, both of which are incorporated herein by reference.

### FIELD OF THE INVENTION

The present invention relates to an acoustic device, and especially relates to a volume control mechanism of a music box. The present invention relates to an acoustic device, such as a music box, having an amplifying member and a sound-pressure controlling mechanism as well.

### BACKGROUND OF THE INVENTION

A conventional acoustic device such as a music box is normally equipped with a sound generating body, for example, a music box sound generating mechanism, in which the rotations of a drive source such as a spring mechanism or a motor are transmitted to a rotary drum via a speed-governed gear mechanism and the pins on the rotary drum pick the reeds arranged according to a given music to play a given melody. This music box sound generating mechanism is fixed inside a wooden case such as a jewelry box or a toy. The vibrations of the reeds, which are the source of the sound, are efficiently resounded inside the wooden case (housing) to increase the volume.

However, once the material, shape and dimension of the wooden case, which is a resonator, and the mounting structure of a movement are determined, the volume of the music box is fixed to the ears of the listener and the listener cannot change the volume according to the environment or his mood.

Also, a music box movement, one of the sound generating bodies of acoustic devices, comprises a plurality of reeds arranged along the scale, a rotary body having pins which pick the reeds in the order corresponding to a predetermined piece of music, a drive source for driving the rotary body, and a rotation-transmitting mechanism. There are a drum-type and a disk-type for the rotary body. Since a loud sound cannot be obtained using only the music box movement with such a configuration, the music box movement is normally installed in a housing such as a resonance box so that the sound is amplified by using the resonance of the housing and the air vibration inside the housing.

However, with the conventional configuration to amplify the sound, the vibrations of multiple frequencies are mixed inside the housing. Consequently it is difficult to take the raw sound generated by the reeds as a pure sound and amplify it. Considering the above problem, an amplifying device of a music box has been proposed, which is disclosed in Japanese Laid-open Patent Application H8-254977, incorporated herein by reference. In that application, the music box movement has a firm contact with a side edge of an amplifying plate on a curved, thin plate; a holding mechanism is provided for holding the amplifying plate in a curved shape by force; and the vibrations generated by the reeds of the music box movement are amplified by the amplifying plate.

In a conventional music box, the sound pressure generated is constant, so the sound pressure cannot be arbitrarily controlled to any level. At best, the resonance condition may be changed by changing the place, stand or table for placing the music box so that the loudness of the sound audible to listener's ears can be changed.

Then, an objective of the present invention is to provide an acoustic device that has a simple configuration but can control the volume anytime without using an expensive electrical amplifier.

The present invention has been devised to solve the above problems in the prior art. An objective of the present invention is to provide an acoustic device in which the sound pressure can be effectively controlled by designing the configuration of the transmitting portion of the vibration from the sound generating body such as a music box movement to the amplifying member and then independent from the material of the elastic member.

### SUMMARY OF THE INVENTION

In order to achieve the above objective, an acoustic device of the present invention comprises a sound generating body and a resonator having a mounting member to which the sound generating body is mounted, wherein a frame of the sound generating body is fixed to the mounting member via a control member that can control the transmission of the vibration energy of the sound generated by the sound generating body.

The control member is arranged to be capable of controlling the contact pressure between the frame of the sound generating body and the mounting member. Further, the control member is an elastic member; when it is provided at two or more places, it is preferred that different sizes, shapes, coefficients of elasticity and mounting conditions be considered. Moreover, the contact pressure can be controlled by a combined function between a deforming means of the elastic member and a manual operation member that is connected to the deforming member.

In one aspect, the invention comprises a sound generating body, an amplifying member for amplifying an audio vibration sound generated by the sound generating body, a holding member for supporting the amplifying member, and a transmitting member for transmitting the vibration generated by the sound generating body to the amplifying member; wherein the transmitting member is arranged to be capable of making contact with or separating from the sound generating body and the amplifying member, and also capable of changing the contact condition between the sound generating body and the amplifying member to control the volume of the sound, which is transmitted from the sound generating body to the amplifying member and is generated at the amplifying member.

The audio vibration sound generated by the sound generating body is transmitted to the amplifying member through the transmitting member. The amplifying member enhances the audio vibration sound transmitted from the sound generating body. The transmitting member changes the contact condition between the sound generating body and the amplifying member so that the efficiency of transmission of the audio vibration sound from the sound generating body to the

amplifying member can be changed; therefore, the loudness of the sound which is generated at the amplifying member can be controlled.

In another aspect of the invention, a vibration-preventing member is provided between the sound generating body and the holding member.

Between the sound generating body and the holding member, the sound from the sound generating body is transmitted to the holding member via the transmitting member and the sound transmission through the other portions is intercepted by the vibration-preventing member. Thus, the sound pressure can be effectively controlled and a good frequency property can be obtained.

In another aspect of the invention, the amplifying member is a plate-like member and the holding member is fixed to a side surface of the amplifying member.

In another aspect of the invention, the sound generating body is a music box movement.

In another aspect of the invention, the sound generating body is attached to an interposing member and the transmitting member is positioned between the interposing member and the amplifying member.

In yet another aspect of the invention, the vibration-preventing member is of a bent shape or a dog-leg.

### BRIEF DESCRIPTION OF THE DRAWINGS

FIG. 1 is a plan view of a cutaway of an embodiment of an acoustic device of the present invention, in which the configuration inside is shown.

FIG. 2 is a side view of a cutaway of FIG. 1 in which the configuration inside is shown.

FIG. 3 is partial side views to show the volume control operation by a volume control lever in the acoustic device of the present invention: FIG. 3(a) shows the condition for the medium volume; and FIG. 3(b) shows the condition for the lowest volume.

FIG. 4 is component diagrams of the volume control lever in the acoustic device of the present invention: FIG. 4(a) is a plan view; and FIG. 4(b) is a side view.

FIG. 5 is component diagrams of the volume control cam member in the acoustic device of the present invention: FIG. 5(a) is a plan view; FIG. 5(b) is a side view; and FIG. 5(c) is a development view showing the changes of the cam in height.

FIG. 6 is a front view of another embodiment of an audio device of the present invention.

FIG. 7 is a plan view of the embodiment of FIG. 6.

FIG. 8 is a front view of another embodiment of the transmitting member that can be applied to the present invention: FIG. 8(a) shows a condition in which the transmitting member is separated from the sound generating body and the amplifying member; and FIG. 8(b) shows a condition in which the transmitting member is in contact with the sound generating body and the amplifying member.

FIG. 9 is a front view of another embodiment of the transmitting member that can be applied to the present invention: FIG. 9(a) shows a condition in which the transmitting member is separated from the sound generating body and the amplifying member; and FIG. 9(b) shows a condition in which the transmitting member is in contact with the sound generating body and the amplifying member.

FIG. 10 is a front view of another embodiment of the transmitting member that can be applied to the present invention: FIG. 10(a) shows a condition in which a vibration-transmitting member, which configures the transmitting member, is separated from the sound generating body and the amplifying member; and FIG. 10(b) shows a condition in which the vibration-transmitting member is in contact with the sound generating body and the amplifying member.

FIG. 11 is a property line diagram showing the results of the measurement of the frequency properties obtained when the transmitting member makes contact with the sound generating body and the amplifying member and when it is separated from them in the embodiment of FIGS. 6 and 7.

FIG. 12 is a front view of another form of the vibration-preventing member which can be applied in the present invention.

FIG. 13 is a property line diagram showing the results of the measurement of the frequency properties obtained when the transmitting member makes contact with the sound generating body and the amplifying member and when it is separated from them in the embodiment of FIG. 12.

FIG. 14 is a front view of another form of the vibration-preventing member which can be applied in the present invention.

FIG. 15 is a front view of another form of the vibration-preventing member which can be applied in the present invention.

### DETAILED DESCRIPTION OF THE INVENTION

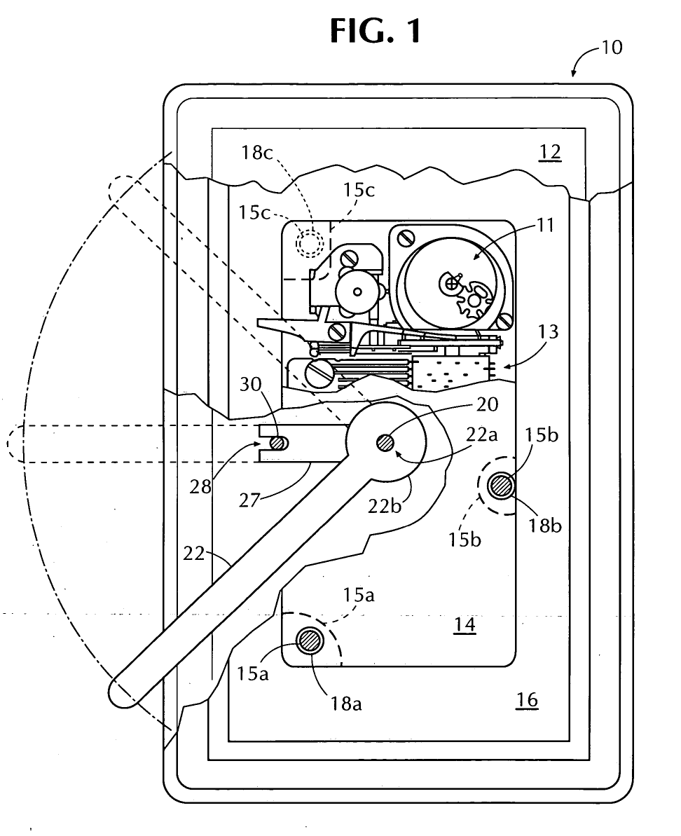

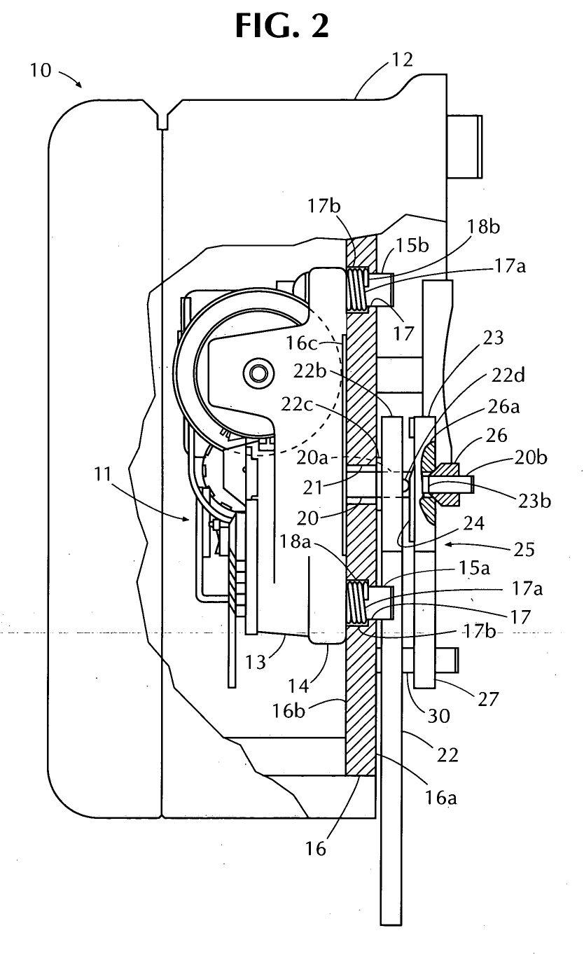

Embodiments of a music box as an acoustic device of the present invention are described hereinafter based on the drawings. FIG. 1 is a plan view of an embodiment of an acoustic device of the present invention. FIG. 2 is a side view of

FIG. 1. Each FIGURE is partially broken to show the configuration inside the acoustic device. Reference number 10 indicates a music box as an acoustic device of this embodiment. A music box sound generating mechanism 11 is placed inside a resonator 12. Note that a cylinder-type music box is shown as the music box sound generating mechanism 11 to describe the embodiment of the music box of the present invention, but the configuration of this type is known well. Therefore, the detailed description is omitted.

On the bottom surface of a base 14 of a frame 13 on which the music box sound generating mechanism 11 is configured, guide pins 15a, 15b, and 15c are formed upright from and integral with a base 14 at three positions. The three positions are not on the same line but are distanced appropriately to form a stable plane. Reference number 16 indicates a mount member which is formed as a portion of the resonator 12, and the music box sound generating mechanism 11 is attached thereon. The guide pins 15a, 15b, and 15c are respectively inserted and positioned into through holes 17 at three positions on the mount member 16.

Each of the through holes 17, into which the guide pins 15a, 15b, 15c are respectively inserted, has a larger diameter portion 17a on the side opposite from the base 14, and compressive coil springs 18a, 18b, and 18c having different spring constants are stored as control members between the bottom surface of the base 14 and the mount member 16. In other words, the compressive coil springs 18a, 18b, and 18c which are respectively interposed between the bottom surface 17b of the larger diameter portion 17a and the bottom surface of the base 14 press the music box sound generating mechanism 11 and the base 14 bottom surface with both ends thereof attached to the bottom surface and the mechanism 11 in the direction to separate them from one another.

In other words, the transmission of the vibration energy of the sound generated by the sound generating body 11 is controlled by the compressive coil springs 18a, 18b, and 18c. Reference number 20 indicates a support shaft, and it is fixed at a median point of the triangle formed by the guide pins 15a, 15b and 15c, by a universal joint almost perpendicular to the bottom surface of the base 14.

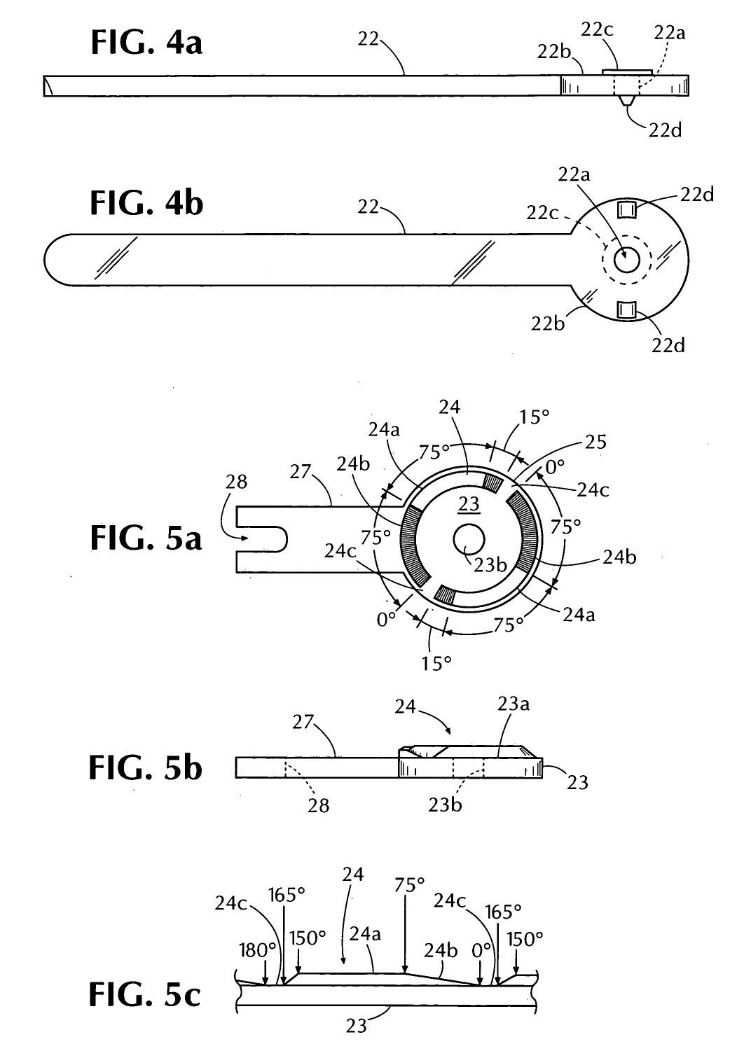

The support shaft 10 is loosely inserted into a through hole 21 formed at the corresponding position on the mount member 16, and projects from another surface 16a of the mount member 16. Then, a shaft hole 22a (see FIG. 4) of a lever 22 is fitted as a manual operation member to a barrel portion 20a of the projecting shaft support 20. The lever 22 is rotatably supported by the support shaft 20 such that a seat surface 22c protruded on a boss 22b, which surrounds the shaft hole 22a, is brought to make contact with another surface 16a of the mount member 16. Further, on the other surface of the boss 22b of the lever 22 from the seat surface 22c, cam followers 22d are provided at two positions along the outer circumference of the boss 22b and symmetrical about the shaft hole 22a to face a cam member 25 as a deforming means (to be described later) (see FIG. 4).

The cam member 25 as the deforming means, which has a cam 24 projected on a surface 23a of the boss 23 facing the boss 22b of the lever 22, is supported such that a center hole 23b of the boss 23 is fitted around the support shaft 20 and supported by a nut 26 which is screwed into an external thread 20b at the tip portion of the support shaft 20. At that time, crest surfaces 24a of the cam 24 and points of the cam followers 22d make a contact with each other and also the base 14 bottom surface of the music box sound generating mechanism 11 makes a firm contact with the facing surface 16b of the mount member 16 to determine the screwing position for the nut 26. An arm 27 is extended from the outer circumference of the boss 23 of the cam member 25 and a U-like cut 28 with one end open, formed in the center in the longitude direction, is engaged with a fixing pin 30 provided on the mount member 16 to prevent the rotation and to position the cam 24 with respect to the circumferential direction. Note that Reference number 16c is a protrusion.

Next described is the operation to increase the volume by controlling the contact pressure between the base 14 of the sound generating body 11 and the mount member 16. The contact pressure is controlled by moving the cam member 25, which is the deforming means for the compressive coil springs 18a, 18b, and 18c as the elastic members, with the lever 22 as the manual operation member. FIG. 2 illustrates that, in the development view of the cam 24 of FIG. 5(c), the cam followers 22d of the lever 22 are positioned within the range of the crest surfaces 24a of the cam 24 (75°-150°). In other words, the cam member 25 pulls the support shaft 20 against the forces of the compressive coil springs 18a, 18b, and 18c through the nut 26 to compress all the springs 18a, 18b, and 18c so that the entire bottom surface of the base 14 of the music box sound generating mechanism 11 and the facing surface 16b of the mount member 16 are maintained in a firm contact condition.

Since the music box sound generating mechanism 11 and the mount member 16 have a firm contact over the entire surfaces, when the music box 10 plays, the vibration sound generated by the music box sound generating mechanism 11 is efficiently transmitted to the mount member 16 which is a portion of the resonator 12.

Consequently, the loudest volume the music box of this embodiment can produce is generated at the resonator 12.

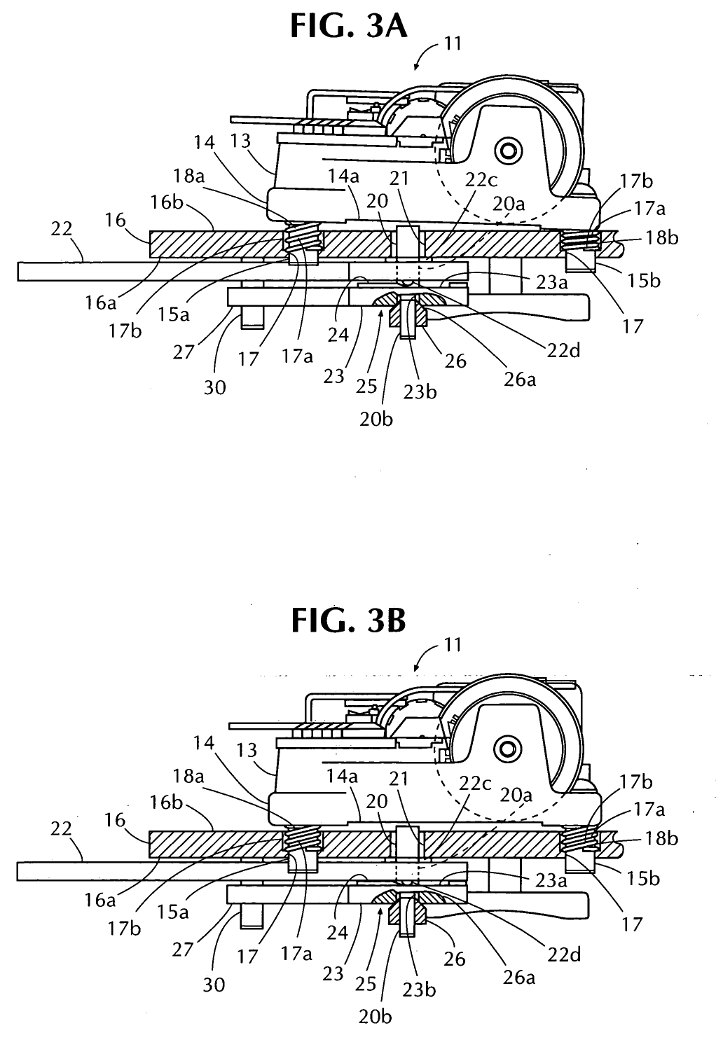

FIG. 3(a) illustrates that the lever is turned and the cam followers 22d are positioned in the range (0°-75°) of the slope surfaces 24b between the crest surfaces 24a of the cam 24 and trough surfaces 24c in the development view of FIG. 5(c). As the cam followers 22d are moved toward the trough surfaces 24c, the facing surfaces of the lever boss 22d and the cam member boss 23a come close to each other, and each of the compressive coil springs 18a, 18b, and 18c, which extends in the axial direction and can be also deformed or displaced, freely stretches according to its own spring constant within its permissive displacement range and moves the base 14 of the music box sound generating mechanism 11 by pressing it in the direction to be away from the mount member 16. This movement relaxes the forces of the compressive coil spring 18a, 18b, and 18c, and therefore, reduces the contact pressure of the both ends of each compressive coil spring 18a, 18b, 18c with respect to the base 14 and the mount member 16. Consequently, the vibration from the music box sound generating mechanism 11 is not easily transmitted, reducing the volume. Note that Reference number 14a is a protrusion.

The compressive coil springs 18a, 18b, and 18c in this embodiment have different spring constants from one another. Therefore, the contact pressure between the base 14 of the music box sound generating mechanism 11 and the mount member 16 differs in respective positions of the springs. For example, FIG. 3(a) shows that the gap at the position of the guide pin 15a to which the compressive coil spring 18a having a large spring constant is attached is larger than the gaps at the positions of the guide pins 15b and 15c to which the compressive coil springs 18b and 18c having smaller spring constants are attached. The total force of the compressive coil springs 18a, 18b, and 18c moves the mount member 16 as well as the lever 22 and the cam member 23 along the support shaft 20 by pressing them in the direction to be away from the base 14. The cam member 23 is press-fitted to the nut 26 and is in equilibrium at every point of the cam slope surfaces 24b; thus, it is supported in a stable manner. The contact surface 26a between the cam member 23 and the nut 26 is formed on the spherical coordinates so that a freedom is given to the coupling of the cam member 23 and the support shaft 20.

When the lever 22 is further turned and the cam followers 22d of the lever 22 are moved toward the trough surfaces 24c of the cam 24 as seen in the development view of the cam 24 of FIG. 5(c), the gaps between the facing surfaces of the base 14 and the mount member 16 at the positions of the guide pins 15a, 15b, and 15c are widened in order of the strength of the spring constants of the compressive coil springs 18a, 18b, and 18c: as the lever 22 is turned, the base 14 and the mount member 16 are first in a linear contact on the line connecting two points at which the spring constants are low, and then gradually come in a point contact at one point at which the spring constant is the lowest. In this manner, the efficiency of the transmission of the vibration is slowly decreased, reducing the volume.

Although the three compressive coil springs 18a, 18b and 18c having different spring constants are used in this embodiment, the present invention is not limited to this. Three compressive coil springs that have the same spring constant may be used. When the coil springs having the same spring constant are used, the condition of the plane contact may become easily unstable, which in turn may cause a chatter noise. In such a case, there is a need of providing a function to prevent the chatter noise. For example, protrusions (15A, 15B, and 15C) may be provided at three positions on the bottom surface of the base 14 (the surface opposite from the mount member 16) and they make firm contacts with the mount member 16.

When the cam followers 22d are positioned in the trough surfaces 24c finally, the base 14 is supported by the total force of the compressive coil springs 18a, 18b and 18c such that the facing surface thereof is completely detached from the mount member 16. Therefore, the vibration from the music box sound generating mechanism 11 is transmitted to the resonator 12 basically only through the compressive coil springs 18a, 18b and 18c, which are interposed between the base 14 and the mount member 16 exerting the force on them with both ends thereof. Since the compressive coil springs 18a, 18b and 18c are the vibration-absorbing members, the vibration generated from the music box sound generating mechanism 11 is transmitted to the resonator 12 only through the contact portion between the support shaft 20 and the nut 26. Thus, the volume becomes the lowest.

Although one embodiment of the music box of the present invention has been described based on the drawings, the present invention is not limited to this, but is anticipated to achieve various changes in the details and improvements of configurations, etc. within the scope of the invention. For example, a rubber cylindrical member may be used in place of the compressive coil spring to control the contact pressure. Also, a linear contact by a wavy stick or a plane contact by a flat spring can be used. A screw member may be used for the cam member as a deforming member, and another manual operation means such as a dial or a handle may be considered beside the lever.

Further, the resonator may not be a wooden case (housing), but a plate member may be attached to the base via the mount member.

Moreover, although this embodiment has used a cylinder-type music box to describe a means for fixing the frame and the mount member through the control member, this means can be also applied in a disk-type music box regardless of the type of the movement.

Another embodiment of the acoustic device of the present invention is described referring to the drawings.

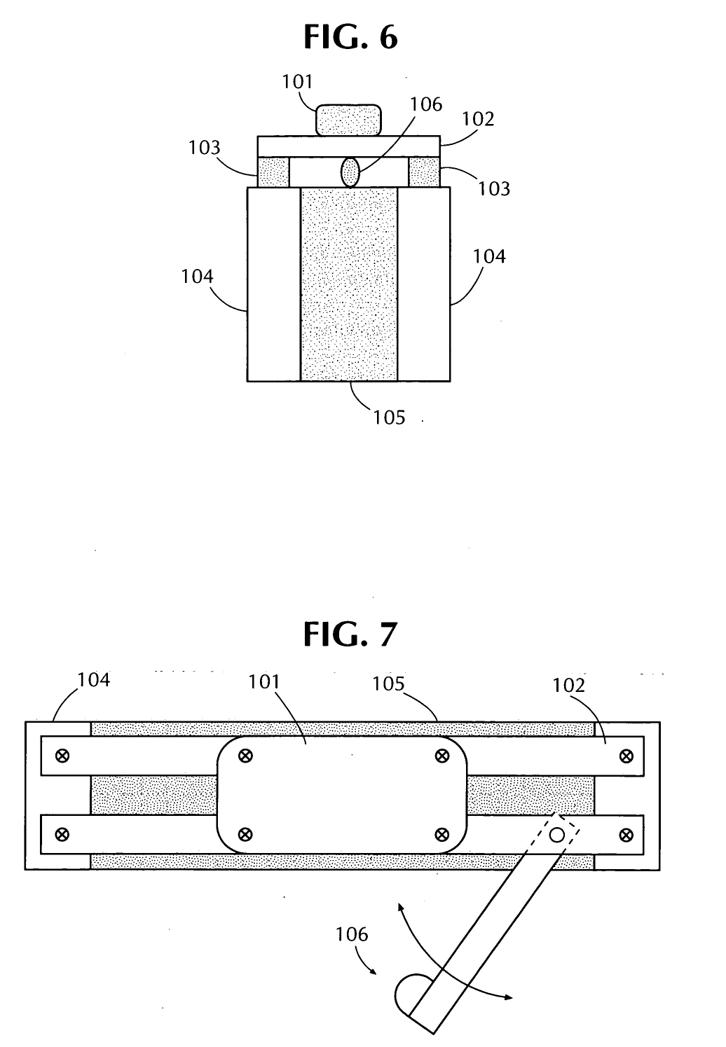

In FIGS. 6 and 7, Reference number 101 is a sound generating body. Although the sound generating body 101 is not specifically limited as long as it generates a sound, a music box movement is used as a sound generating body in this embodiment. The sound generating body 101 has a base, which is attached to two interposing members 102 arranged parallel to each other along the horizontal direction. The two interposing members 102 are connected to an amplifying member 105 via a pair of support members 103, both ends in the longitude direction of which also function as a vibration-preventing member. Note that the amplifying member is a plate member; a pair of holding members 104 are fixed along the left and right side edges of the plate-like amplifying member 105; and the two interposing members 102 are connected to the top surfaces of the holding members 104 via the support members 103.

The amplifying member 105 can be configured by curving a plate-like member in a smooth wavy shape. To maintain the curve of the amplifying member 105, both side surfaces of the amplifying member 105 are held by the holding members 104, and the sound generating body 101 is connected to one of the end surfaces of the amplifying member 105, i.e., the top surface in the embodiment illustrated in the FIGURE. The amplifying member 105 may be a plate-like member composed of a material such as a wood, a cardboard, a nonwoven fabric, a synthetic resin plate, an FRP, a metallic plate, or a compound material of the above. With the curved surface, the amplifying member 105 can obtain the amplifying effects by concentrating the acoustic energy in a specific direction without dispersing it. As the audio vibration sound from the sound generating body is transmitted to a portion of the end surface of the amplifying member 105, the amplifying effects can be obtained.

The support members 103 do not necessarily function as the vibration-preventing member, but a wooden material may be used for the support members, for example. However, it is still desirable to use a vibration-preventing member for the support members. The vibration-preventing member can be an elastic member such as a rubber or a general shock-absorbing member.

A transmitting member 106 is positioned between the sound generating body 101 and the amplifying member 105, more accurately, between the interposing members 102, which are substantially connected to the sound generating body 101, and the top end surface of the amplifying member 105. The transmitting member 106 is positioned capable of making contact with and separating from the sound generating body 101 and the amplifying member 105. By making the transmitting member 6 contact with the sound generating body 1 and the amplifying member 105 and separating it from them, the loudness of the sound which is transmitted from the sound generating body 101 to the amplifying member 105 and then generated at the amplifying member 105 can be roughly controlled. Also, by changing the material for the transmitting member 6 or changing the connecting position of the sound generating body 101 and the amplifying member 105, i.e., by changing the contact condition between the sound generating body 101 and the amplifying member 105, the volume of the sound, which is transmitted from the sound generating body 101 to the amplifying member 105 and then generated at the amplifying member 105, can be controlled.

In this embodiment, as illustrated in FIG. 7, the amplifying member 105 is positioned at the tip of a lever, which is attached to the bottom surface of one of the interposing members 102 to be rotatable in a horizontal plane around the axis in the perpendicular direction. As this lever is revolved, the transmitting member 106 can come in contact with or separate from the sound generating body 101 (the interposing members 102 substantially connected to the body 101) and the amplifying member 105. With this, the sound pressure can be roughly controlled. The transmitting member 106 is formed in a wedge shape; by controlling the contact condition of the transmitting member with the sound generating body 101 and the amplifying member 105 such as by adjusting the tightness of fitting of the transmitting member between the sound generating body 101 and the amplifying member 105, the efficiency of the sound transmission between the sound generating body 101 and the amplifying member 105 can be changed so that the volume of the sound generated at the amplifying member 105 can be precisely controlled.

Further, a material having a high density such as a metal may be used as the material for the transmitting member, or the transmitting member 106 can be connected with the amplifying member 105 right below the sound generating body 101, to increase the sound pressure. On the other hand, a material having a low density such as wood may be used for the transmitting member 106, or the transmitting member 106 may be connected with the amplifying member 105 being away from the sound generating body 101 but in the vicinity of the support members 103, in order to reduce the sound pressure. Thus, a precise sound pressure control can be performed.

FIG. 11 shows the results of the frequency properties obtained when the transmitting member 106 makes contact with the sound generating body 101 (the interposing members 102 substantially connected to the body 101) and the amplifying member 105 and when it is separated from them, in the embodiment of FIGS. 6 and 7. In FIG. 11, the horizontal axis is the frequency of the sound, and the vertical axis is the sound pressure. The curve shown by the solid line is the frequency property obtained when the transmitting member 106 makes contact with the sound generating body 101 (the interposing members 102 substantially connected to the body 101) and the amplifying member 105, that is, when the audio vibration sound is transmitted from the sound generating body 101 to the amplifying member 105. The curve shown by the dotted line is the frequency property obtained when the transmitting member 6 is separated from the amplifying member 105, that is, when the transmission of the audio vibration sound from the sound generating body 101 to the amplifying member 105 is intercepted.

As understood from the property curves in FIG. 11, the sound pressure levels are controlled almost evenly over the entire audio range in an effective manner. Also, it can be assumed from the curves in FIG. 11, by controlling the contact condition of the transmitting member 6 with the sound generating body 101 and the amplifying member 105, the efficiency of the sound transmission from the sound generating body 101 to the amplifying member 105 can be changed to precisely control the volume of the sound which is generated at the amplifying member 105.

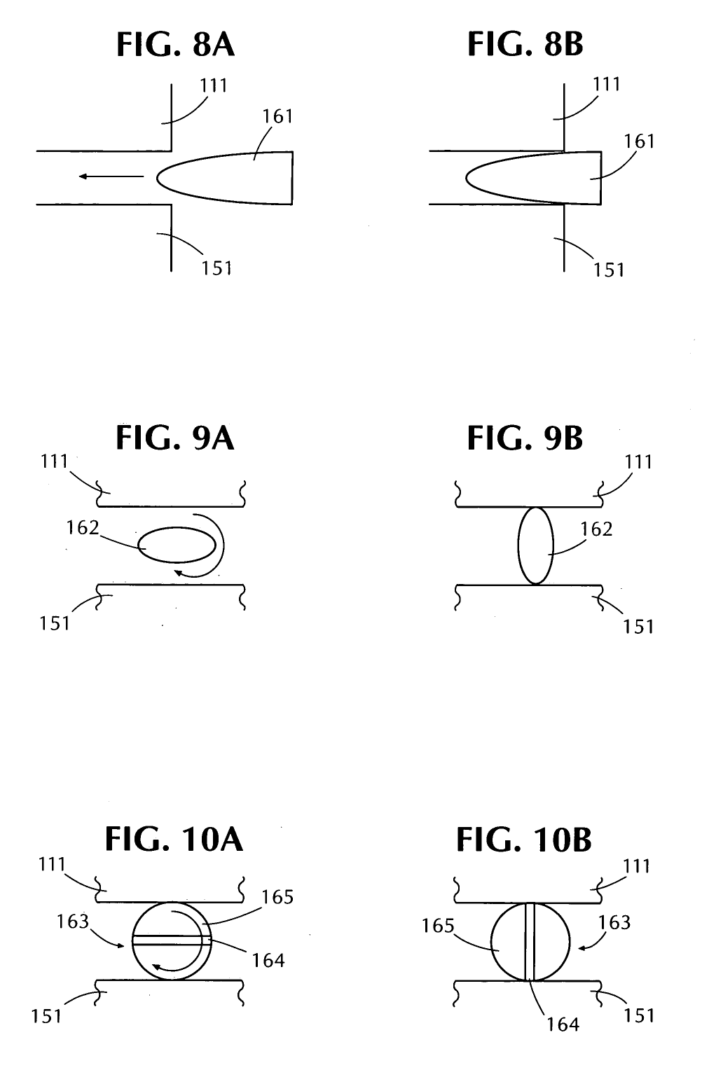

The transmitting member, which makes contact with or detaches from the sound generating body 101 (or the interposing members 102 substantially connected to the body 101) and the amplifying member 105, can be modified in various forms. FIGS. 8 through 10 show examples of the various modifications of the transmitting member. In FIGS. 8 through 10, Reference number 111 indicates a sound generating body (or the interposing members substantially connected to the body 101) and Reference number 151 indicates an amplifying member. The bottom surface of the sound generating body 111 and the top surface of the amplifying member 151 are opposed from each other with a predetermined gap. The transmitting member comes into the gap, wherein it can make contact with the sound generating body 111 and the amplifying member 151 or separate from them.

FIG. 8 illustrates an example in which a transmitting member 161 composed of an ammunition-like wedge is inserted into the gap between the sound generating body 111 and the amplifying member 151 to connect the body 111 and the member 151 (see FIG. 8(b)) and also removed from the gap to separate the body 111 from the member 151 (see FIG. 8(a)). In this manner, the transmission of the audio vibration sound from the sound generating body 111 to the amplifying member 151 is changed in different levels so that the pressure level of the sound generated can be controlled to high or low. The transmitting member 161 can be made to contact with and to be separated from the sound generating body 111 and the amplifying member 151, and also can change the firmness of its contact, i.e., its contact condition with the sound generating body 111 and the amplifying member 151. By doing this, the loudness of the sound which is transmitted from the sound generating body 111 to the amplifying member 151 and then generated at the amplifying member 151 can be controlled.

FIG. 9 shows an example in which a transmitting member 162 having an oval cross-section is supported to be rotatable in a perpendicular plane inside a gap between the sound generating body 111 and the amplifying member 151; FIG. 9(a) shows that the transmitting member 162 is positioned horizontally so that the sound generating body 111 and the amplifying member are not connected; FIG. 9(b) shows that the transmitting member 162 is positioned vertically to provide contact between the sound generating body 11 and the amplifying member 151. These positions can be switched. Even in this example, the pressure level of the sound generated can be switched in different levels. Also, the firmness of the contact, i.e., the contact condition of the transmitting member 151 with the sound generating body 111 and the amplifying member 151 can be changed so that the loudness of the sound which is transmitted from the sound generating body 111 to the amplifying member 151 and generated at the amplifying member 151 can be controlled.

FIG. 10 shows an example in which a disk-like transmitting member 163 is supported to be rotatable in a perpendicular plane inside the gap between the sound generating body 111 and the amplifying member 151. The transmitting member 163 consists of a vibration-transmitting member 164, which passes through the center of circle and extends in the diameter direction, and a vibration-preventing member 165, which sandwiches the vibration-transmitting member 164 from both sides and forms a circular outer circumference together with the vibration-transmitting member 164; the outer circumference is always in contact with the sound generating body 111 and the amplifying member 151. The transmitting member 63 can be switched in two positions: the position illustrated in FIG. 10(a), in which the vibration-transmitting member 164 is positioned to be horizontal so that the vibration-preventing member 165 makes contact with the sound generating body 111 and the amplifying member 151; and the position illustrated in FIG. 10(b), in which the vibration-transmitting member 164 is positioned to be vertical so that the vibration-transmitting member 164 makes contact with the sound generating body 111 and the amplifying member 151. Under the condition of FIG. 10(a), the audio vibration sound is not easily transmitted from the sound generating body 111 to the amplifying member 151, generating a low sound pressure. Under the condition of FIG. 10(b), the audio vibration sound is efficiently transmitted from the sound generating body 111 to the amplifying member 151, generating a high sound pressure. As shown in the example of FIG. 10, by controlling the contact condition of the vibration-transmitting member 164, which configures the transmitting member 163, with the sound generating body 111 and the amplifying member 151, i.e., by adjusting the contact angle of the vibration-transmitting member 164 with respect to the sound generating body 111 and the amplifying member 151, the transmission of the audio vibration sound from the sound generating body 111 to the amplifying member 151 can be controlled, and thus the sound pressure level can be continuously controlled.

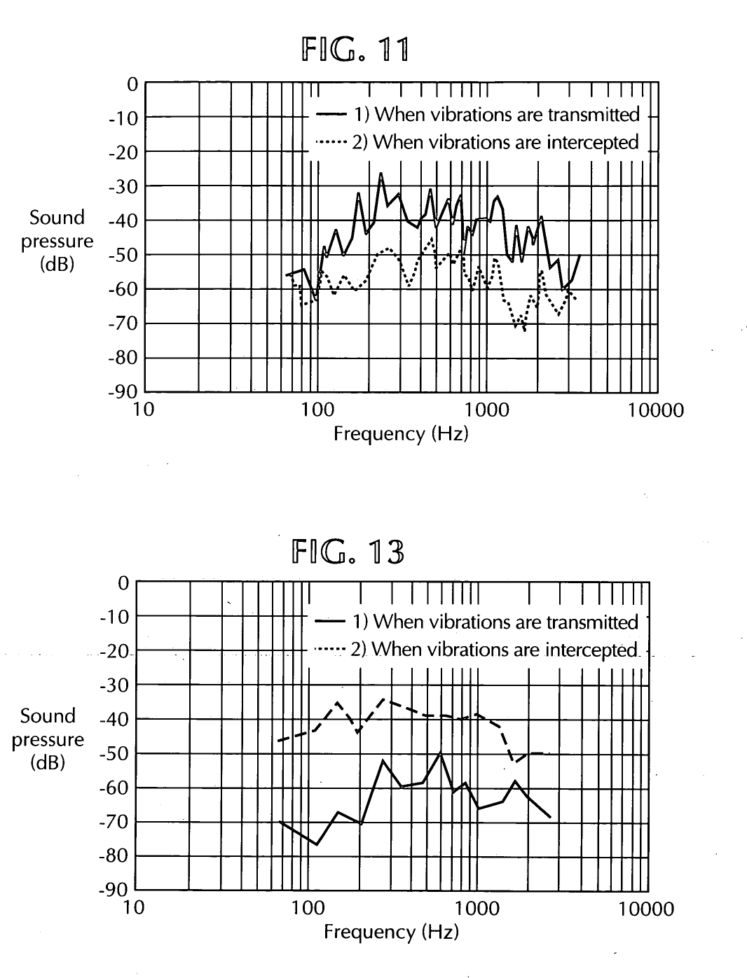

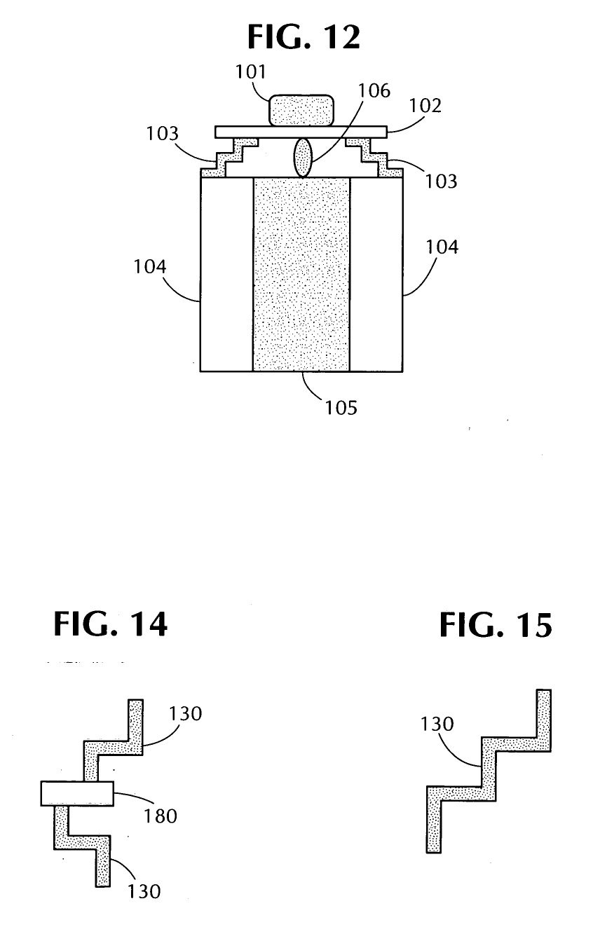

Also, beside the elastic member or the shock-absorbing member, the vibration-preventing member can be provided by bending a metallic bar or a metallic plate, as illustrated as a vibration-preventing member 103 in FIG. 12. In such a case, where to bend is not limited to this. Also, the metallic material can be aluminum, iron, etc.; however, it is not limited to these.

FIG. 13 shows the results of the frequency properties obtained when the transmitting member 106 makes contact with the sound generating body 101 (the interposing members 102 substantially connected to the body 101) and the amplifying member 105 and when it is separated from them in the embodiment illustrated in FIG. 12. In the same manner as the description of FIG. 11, as understood from the property curves of FIG. 13, the sound pressure level is controlled almost evenly over the entire audio range in an effective manner.

Furthermore, as illustrated in FIG. 14, between two vibration-preventing members 130 and 130, a member 180 composed of a material different from that of the members 130 and 130 may be interposed. This increases the effectiveness in intercepting the vibrations.

As described above, the acoustic device of the present invention comprises a sound generating body, and a resonator having a mount member to which the sound generating body is mounted; wherein the frame of the sound generating body and the mount member are fixed via the control member that can control the transmission of the vibration energy of the sound generated by the sound generating body. Therefore, a portion of the vibration which would be transmitted to the resonator is absorbed, and thus the volume is freely controlled.

According to one aspect of the invention, the control member is attached so as to adjust the contact pressure between the frame of the sound generating body and the mount member. Therefore, the amount of the vibration energy, which is transmitted to the resonator, can be changed according to the contact pressure, thus controlling the volume freely.

According to another aspect of the invention, the control member is an elastic member; when it is provided at two or more positions, different sizes, shapes, coefficients of elasticity, and mounting conditions need to be considered. Therefore, the vibration frequency and the amount of the vibration energy, which are transmitted to the resonator, defer according to the contact condition between the frame and the mount member; thus, the sound quality as well as the volume can be changed.

According to another aspect of the invention, the contact pressure can be controlled by a combined function of the deforming means for the elastic member and the manual operation member, which is connected to the deforming means. Therefore, through a simple revolving operation by hand, such as a lever, the force of the elastic member is changed via the deforming means such as the cam, screw, wedge, etc. so that the contact pressure between the frame and the mount member is freely and continually changed to increase/reduce the volume. Consequently, a listener can enjoy the music with the volume suitable for the atmosphere in which the acoustic device can be easily listened or with the volume the listener is comfortable with.

According to another aspect of the invention, the transmitting member is brought to make contact with or is separated from the sound generating body and the amplifying member to change the transmission condition of the audio vibration sound from the sound generating body to the amplifying member so that the pressure level of the sound generated can be switched to high and low. Also, the contact condition of the transmitting member with the sound generating body and the amplifying member can be changed to change the efficiency in transmitting the audio vibration sound which is transmitted from the sound generating body to the amplifying member so that the loudness of the sound generated at the amplifying member can be controlled. Unlike a conventional amplifying means by a housing such as a resonance box in which multiple frequency vibrations are mixed inside the housing, the vibration sound generated by the sound generating body can be transmitted to the amplifying member as it is. Therefore, the sound pressure of a pure vibration sound which is generated by the sound generating body can be controlled.

According to another aspect of the invention, the vibration-preventing member is provided between the sound generating body and a holding member. Therefore, between the sound generating member and the holding member, the sound from the sound generating body is transmitted to the holding member through the transmitting member and the transmission of the sound from other portions is intercepted by the vibration-preventing member. Consequently the sound pressure can be effectively controlled and a good frequency property can be obtained.

The foregoing specific embodiments represent just some of the ways of practicing the present invention. Many other embodiments are possible within the spirit of the invention. Accordingly, the scope of the invention is not limited to the foregoing specification, but instead is given by the appended claims along with their full range of equivalents.

What is claimed is:

1. An acoustic device comprising:
a sound generating body; and
a resonator having a mount member to which said sound generating body is mounted;
wherein a frame of said sound generating body and said mount member are fixed via a control member which can control the transmission of the vibration energy of the sound generated by said sound generating body.

2. The acoustic device as set forth in claim 1, wherein said control member is attached so as to control a contact pressure between said frame of said sound generating body and said mount member.

3. The acoustic device as set forth in claim 2, wherein said control member is an elastic member; when said control member is provided at two or more positions, different sizes, shapes, coefficients of elasticity, and mounting conditions need to be considered.

4. The acoustic device as set forth in claim 3, wherein said contact pressure can be controlled by a combined function of a deforming means of said elastic member and a manual operation member connected to said deforming member.

5. An acoustic device comprising:
a sound generating body;
an amplifying member for amplifying the audio vibration sound generated by said sound generating body;
a holding member for supporting said amplifying member; and
a transmitting member for transmitting said vibration, which is generated by said sound generating body, to said amplifying member;
wherein said transmitting member is arranged to make contact with or detach from said sound generating body and said amplifying member, and also to change the contact condition between said sound generating body and said amplifying member so that the volume of the sound which is transmitted from said sound generating body to said amplifying member and is generated at said amplifying member is controlled.

6. The acoustic device as set forth in claim 5, wherein a vibration-preventing member is provided between said sound generating body and said holding member.

7. The acoustic device as set forth in claim 5, wherein said amplifying member is a plate-like member, and said holding member is fixed to a side surface of said amplifying member.

8. The acoustic device as set forth in claim 5, wherein said sound generating body is a music box movement.

9. The acoustic device as set forth in claim 5, wherein said sound generating body is attached to an interposing member, and said transmitting member is arranged between said interposing member and said amplifying member.

10. The acoustic device as set forth in claim 6, wherein said vibration-preventing member is of a bent shape.

11. An acoustic device comprising:
a sound generating body;
a resonator having a mount member to which the sound generating body is mounted; and
a sound control member that controls the transmission of sound from the sound generating body to the resonator to control the sound volume.

12. The acoustic device according to claim 11, wherein the sound control member is coupled to the sound generating body and the mount member, and is operable to adjust a contact pressure between the sound generating body and the mount member to vary the sound volume.

13. The acoustic device according to claim 12, wherein the sound control member includes at least one elastic member disposed between the sound generating body and the mount member.

14. The acoustic device according to claim 12, wherein the sound control member includes a plurality of elastic members spaced apart from each other and attached to both the sound generating body and the mount member, at least one of the elastic members having a different elasticity than the other elastic members.

15. An acoustic device comprising:
a sound generating body;
an amplifying member operable to non-electrically amplify sound generated by the sound generating body; and
a transmitting member operable to transmit the sound generated by the sound generating body to the amplifying member;
wherein the transmitting member is disposed to couple the sound generating body and the sound generating body together and to decouple the sound generating body from the amplifying member.

16. The acoustic device according to claim 15, wherein the transmitting member is operable to adjust the contact condition between the sound generating body and the amplifying member so as to vary the extent to which the sound is transmitted from the sound generating body to the amplifying member.

17. The acoustic device according to claim 15, further comprising a vibration-preventing member disposed between the sound generating body and the holding member.

18. The acoustic device according to claim 17, wherein the vibration-preventing member has a bent dog-leg portion.

19. The acoustic device according to claim 15, further comprising:
a holding member that supports the amplifying member;
wherein the amplifying member includes a plate-like member and the holding member is fixed to a side surface of the amplifying member.

20. The acoustic device according to claim 15, wherein the sound generating body is a music box movement.
